(19) United States
(12) Patent Application Publication
(10) Pub. No.: US 2018/0095802 A1
(43) Pub. Date: Apr. 5, 2018

(54) HARDWARE STRESS INDICATORS BASED ON ACCUMULATED STRESS VALUES

(71) Applicant: Intel Corporation, Santa Clara, CA (US)

(72) Inventors: Hang T. Nguyen, Tempe, AZ (US); Gordon McFadden, Beaverton, OR (US); Pradeepsunder Ganesh, Chandler, AZ (US); Stephen Thomas Palermo, Paradise Valley, AZ (US); Travis J. White, Queen Creek, AZ (US); Ashok Raj, Portland, OR (US); Vivek Garg, Folsom, CA (US); Dhruv Singh, Hillsboro, OR (US)

(73) Assignee: Intel Corporation, Santa Clara, CA (US)

(21) Appl. No.: 15/283,006

(22) Filed: Sep. 30, 2016

(51) Int. Cl. G06F 9/50

(52) U.S. Cl. CPC G06F 9/5044; G06F 9/5094

(57) ABSTRACT

In one embodiment, a method comprises determining, at a plurality of instances in time, a value of at least one stress characteristic of a hardware resource; determining an accumulated stress value of the hardware resource, the accumulated stress value comprising the sum of a plurality of incremental stress values, an incremental stress value determined based on the value of the at least one stress characteristic at a particular instance in time; and generating a first stress indicator in response to a determination that the accumulated stress value of the hardware resource is greater than a first threshold stress value associated with the hardware resource.

### BACKGROUND

A computer system may include one or more platforms each comprising one or more processors and/or one or more memory modules. A platform of a computer system may facilitate the performance of any suitable number of workloads associated with various applications running on the platform. These workloads may be performed by processors and/or other associated logic of the platforms.

### BRIEF DESCRIPTION OF THE DRAWINGS

FIG. 1 illustrates a block diagram of components of a computer system in accordance with certain embodiments.

FIG. 2 illustrates a block diagram of a central processing unit in accordance with certain embodiments.

FIG. 3 illustrates a block diagram of a system management platform in accordance with certain embodiments.

FIG. 4 illustrates an example flow for generating a stress indicator based on an accumulated stress value of a hardware resource in accordance with certain embodiments.

FIG. 5 illustrates an example flow for determining a stress accumulation rate for a hardware resource in accordance with certain embodiments.

FIG. 6 illustrates an example flow for selecting hardware resources for a workload based on remaining life of hardware resources in accordance with certain embodiments.

FIG. 7 depicts an example data structure that may be used to track stress information of a plurality of hardware resources.

Like reference numbers and designations in the various drawings indicate like elements.

### DETAILED DESCRIPTION

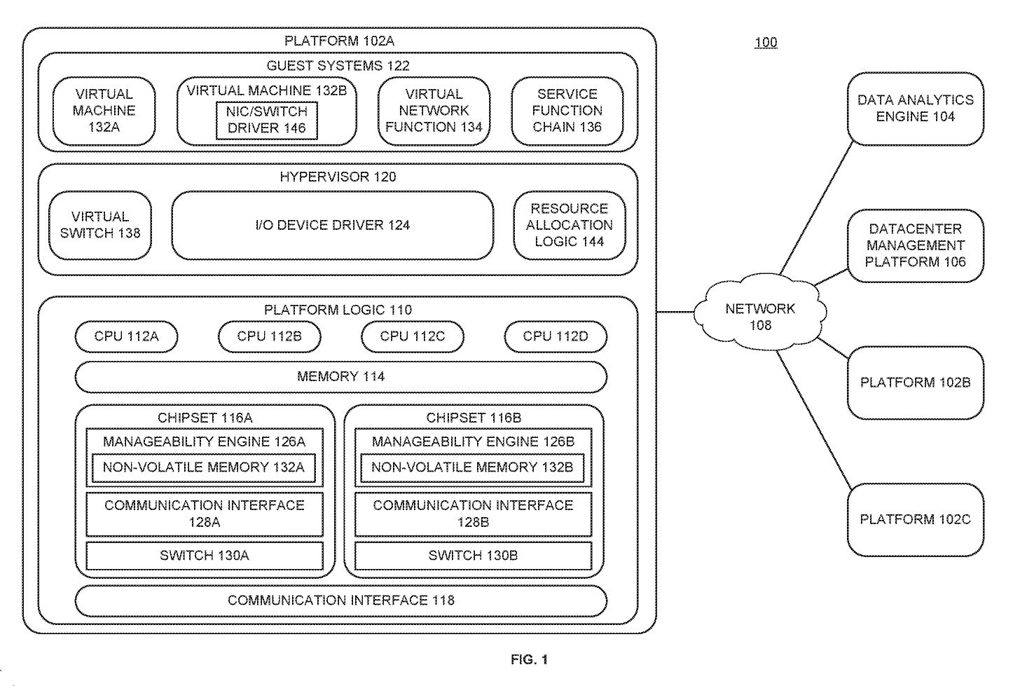

FIG. 1 illustrates a block diagram of components of a computer system 100 in accordance with certain embodiments. In the embodiment depicted, computer system 100 includes a plurality of platforms 102 and system management platform 106 coupled together through network 108. In other embodiments, a computer system may include any suitable number of (i.e., one or more) platforms. In some embodiments (e.g., when a computer system only includes a single platform), all or a portion of the system management platform 106 may be included on a platform 102. A platform 102 may include platform logic 110 with one or more central processing units (CPUs) 112, memories 114 (which may include any number of different modules), chipsets 116, communication interfaces 118, and/or any other suitable hardware and/or software to execute a hypervisor 120 or other operating system capable of executing workloads associated with applications running on platform 102. In some embodiments, a platform 102 may function as a host platform for one or more guest systems 122 that invoke these applications. System 100 may represent any suitable computing environment, such as a high performance computing environment, a datacenter, a communications service provider infrastructure (e.g., one or more portions of an Evolved Packet Core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated of a plurality of hardware resources (e.g., cores, uncores, or other components) are monitored and entities (e.g., system management platform 106, hypervisor 120, or other operating system) of computer system 100 may assign hardware resources of platform logic 110 to perform workloads in accordance with the stress information. For example, system management platform 106, hypervisor 120 or other operating system, or CPUs 112 may determine one or more cores to schedule a workload onto based on the stress information. In some embodiments, self-diagnostic capabilities may be combined with the stress monitoring to more accurately determine the health of the hardware resources. Such embodiments may allow optimization in deployments including Network Function Virtualization (NFV), Software Defined Networking (SDN), or Mission Critical applications. For example, the stress information may be consulted during the initial placement of VNFs (Virtual Network Functions) or for migration from one platform to another in order to improve reliability and capacity utilization.

Each platform 102 may include platform logic 110. Platform logic 110 comprises, among other logic enabling the functionality of platform 102, one or more CPUs 112, memory 114, one or more chipsets 116, and communication interface 118. In various embodiments, platform logic may include a subset of such components. Although three platforms are illustrated, computer system 100 may include any suitable number of platforms. In various embodiments, a platform 102 may reside on a circuit board that is installed in a chassis, rack, or other suitable structure that comprises multiple platforms coupled together through network 108 (which may comprise, e.g., a rack or backplane switch).

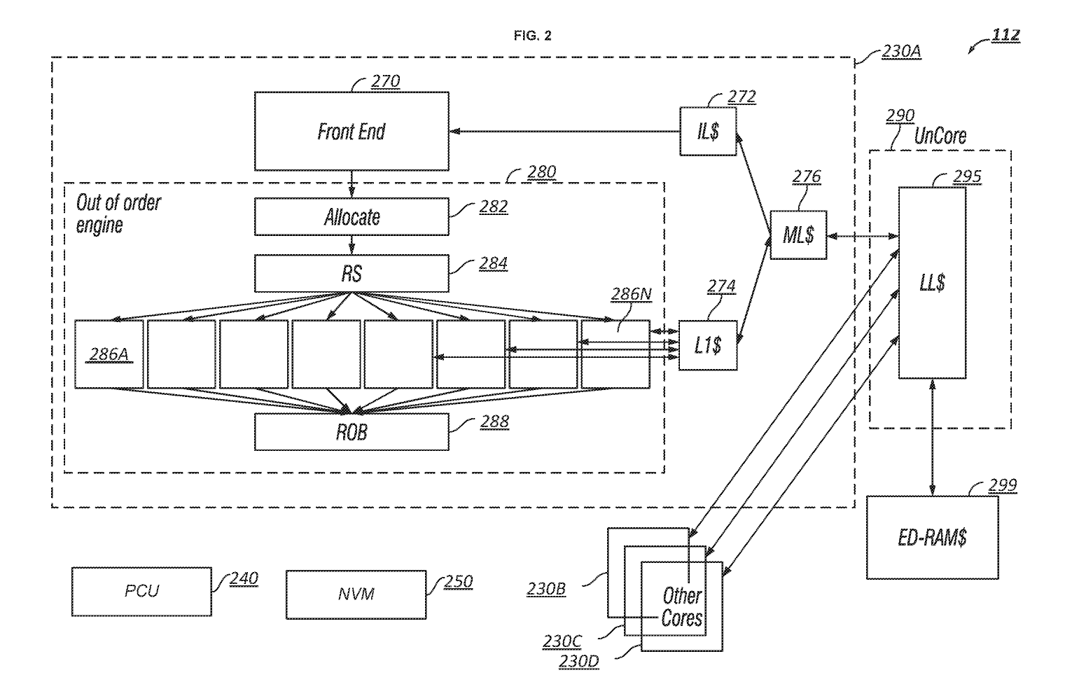

CPUs 112 may each comprise any suitable number of processor cores and supporting logic (e.g., uncores). The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removeably coupled to platform 102. CPU 112 is described in further detail below in connection with FIG. 2. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with the manageability engine 126 or other components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

In various embodiments, memory 114 may store stress information (such as accumulated stress values associated with hardware resources of platform logic 110 in non-volatile memory, such that when power is lost, the accumulated stress values are maintained). In particular embodiments, a hardware resource may comprise non-volatile memory (e.g., on the same die as the particular hardware resource) for storing the hardware resource's accumulated stress value.

A platform 102 may also include one or more chipsets 116 comprising any suitable logic to support the operation of the CPUs 112. In various embodiments, chipset 116 may reside on the same die or package as a CPU 112 or on one or more different dies or packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

In the embodiment depicted, each chipset 116 also includes a manageability engine 126. Manageability engine 126 may include any suitable logic to support the operation of chipset 116. In a particular embodiment, manageability engine 126 (which may also be referred to as an innovation engine) is capable of collecting real-time telemetry data from the chipset 116, the CPU(s) 112 and/or memory 114 managed by the chipset 116, other components of platform logic 110, and/or various connections between components of platform logic 110. In various embodiments, the telemetry data collected includes the stress information described herein.

In various embodiments, the manageability engine 126 operates as an out-of-band asynchronous compute agent which is capable of interfacing with the various elements of platform logic 110 to collect telemetry data with no or minimal disruption to running processes on CPUs 112. For example, manageability engine 126 may comprise a dedicated processing element (e.g., a processor, controller, or other logic) on chipset 116 which provides the functionality of manageability engine 126 (e.g., by executing software instructions), thus conserving processing cycles of CPUs 112 for operations associated with the workloads performed by the platform logic 110. Moreover the dedicated logic for the manageability engine 126 may operate asynchronously with respect to the CPUs 112 and may gather at least some of the telemetry data without increasing the load on the CPUs.

The manageability engine 126 may process telemetry data it collects (specific examples of the processing of stress information will be provided herein). In various embodiments, manageability engine 126 reports the data it collects and/or the results of its processing to other elements in the computer system, such as one or more hypervisors 120 or other operating systems and/or system management software (which may run on any suitable logic such as system management platform 106). In some embodiments, the telemetry data is updated and reported periodically to one or more of these entities. In particular embodiments, a critical event such as a core that has accumulated an excessive amount of stress may be reported prior to the normal interval for reporting telemetry data (e.g., a notification may be sent immediately upon detection).

In various embodiments, a manageability engine 126 may include programmable code configurable to set which CPU(s) 112 a particular chipset 116 will manage and/or which telemetry data will be collected.

Chipsets 116 also each include a communication interface 128. Communication interface 128 may be used for the communication of signaling and/or data between chipset 116 and one or more I/O devices, one or more networks 108, and/or one or more devices coupled to network 108 (e.g., system management platform 106). For example, communication interface 128 may be used to send and receive network traffic such as data packets. In a particular embodiment, communication interface 128 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 116 (e.g., manageability engine 126 or switch 130) and another device coupled to network 108. In some embodiments, network 108 may comprise a switch with bridging and/or routing functions that is external to the platform 102 and operable to couple various NICs distributed throughout the computer system 100 (e.g., on different platforms) to each other. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interface 128 may allow communication of data (e.g., between the manageability engine 126 and the system management platform 106) associated with management and monitoring functions performed by manageability engine 126. In various embodiments, manageability engine 126 may utilize elements (e.g., one or more NICs) of communication interface 128 to report the telemetry data (e.g., to system management platform 106) in order to reserve usage of NICs of communication interface 118 for operations associated with workloads performed by platform logic 110. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 (e.g., one or more Peripheral Component Interconnect Express (PCIe) lanes coupled to CPUs 112). Switch 130 may be a physical or virtual (i.e., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical NICs. These NICs may enable communication between any suitable element of platform logic 110 (e.g., CPUs 112 or memory 114) and another device coupled to network 108 (e.g., elements of other platforms or remote computing devices coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112).

Platform logic 110 may receive and perform any suitable types of workloads. A workload may include any request to utilize one or more resources of platform logic 110, such as one or more cores or associated logic. For example, a workload may comprise a request to instantiate a software component, such as an I/O device driver 124 or guest system 122; a request to process a network packet received from a virtual machine 132 or device external to platform 102 (such as a network node coupled to network 108); a request to execute a process or thread associated with a guest system 122, an application running on platform 102, a hypervisor 120 or other operating system running on platform 102; or other suitable processing request.

In various embodiments, platform 102 may execute any number of guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address or other identifier, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g. firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may also include resource allocation logic 144 which may include logic for determining allocation of platform resources based on the telemetry data (which may include stress information). Resource allocation logic 144 may also include logic for communicating with various components of platform logic 110 entities of platform 102 to implement such optimization, such as components of platform logic 102. For example, resource allocation logic 144 may direct which hardware resources of platform logic 110 will be used to perform workloads based on stress information.

Any suitable logic may make one or more of these optimization decisions. For example, system management platform 106; resource allocation logic 144 of hypervisor 120 or other operating system; or other logic of platform 102 or computer system 100 may be capable of making such decisions (either alone or in combination with other elements of the platform 102). In a particular embodiment, system management platform 106 may communicate (using in-band or out-of-band communication) with the hypervisor 120 to specify the optimizations that should be used in order to meet policies stored at the system management platform.

In various embodiments, the system management platform 106 may receive telemetry data from and manage workload placement across multiple platforms 102. The system management platform 106 may communicate with hypervisors 120 (e.g., in an out-of-band manner) or other operating systems of the various platforms 102 to implement workload placements directed by the system management platform.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the computer system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the computer system 100 through network 108.

FIG. 2 illustrates a block diagram of a central processing unit (CPU) 112 in accordance with certain embodiments. Although CPU 112 depicts a particular configuration, the cores and other components of CPU 112 may be arranged in any suitable manner. CPU 112 may comprise any processor or processing device, such as a microprocessor, an embedded processor, a digital signal processor (DSP), a network processor, an application processor, a co-processor, a system on a chip (SOC), or other device to execute code. CPU 112, in the depicted embodiment, includes four processing elements (cores 230 in the depicted embodiment), which may include asymmetric processing elements or symmetric processing elements. However, CPU 112 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 112 may include any suitable number of cores. In various embodiments, cores may include one or more out-of-order processor cores or one or more in-order processor cores. However, cores may be individually selected from any type of core, such as a native core, a software managed core, a core adapted to execute a native Instruction Set Architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 230A includes an out-of-order processor that has a front end unit 270 used to fetch incoming instructions, perform various processing (e.g. caching, decoding, branch predicting, etc.) and passing instructions/operations along to an out-of-order (OOO) engine 280. OOO engine 280 performs further processing on decoded instructions.

A front end 270 may include a decode module coupled to fetch logic to decode fetched elements. Fetch logic, in one embodiment, includes individual sequencers associated with thread slots of cores 230. Usually a core 230 is associated with a first ISA, which defines/specifies instructions executable on core 230. Often machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 230 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 230, in one embodiment, recognize the same ISA (or a subset thereof). Alternatively, in a heterogeneous core environment, a decoder of one or more cores (e.g., core 230B) may recognize a second ISA (either a subset of the first ISA or a distinct ISA).

In the embodiment depicted, out-of-order engine 280 includes an allocate unit 282 to receive decoded instructions, which may be in the form of one or more micro-instructions or uops, from front end unit 270, and allocate them to appropriate resources such as registers and so forth. Next, the instructions are provided to a reservation station 284, which reserves resources and schedules them for execution on one of a plurality of execution units 286A-286N. Various types of execution units may be present, including, for example, arithmetic logic units (ALUs), load and store units, vector processing units (VPUs), floating point execution units, among others. Results from these different execution units are provided to a reorder buffer (ROB) 288, which take unordered results and return them to correct program order.

In the embodiment depicted, both front end unit 270 and out-of-order engine 280 are coupled to different levels of a memory hierarchy. Specifically shown is an instruction level cache 272, that in turn couples to a mid-level cache 276, that in turn couples to a last level cache 295. In one embodiment, last level cache 295 is implemented in an on-chip (sometimes referred to as uncore) unit 290. Uncore 290 may communicate with system memory 299, which, in the illustrated embodiment, is implemented via embedded DRAM (eDRAM). The various execution units 286 within out-of-order engine 280 are in communication with a first level cache 274 that also is in communication with mid-level cache 276. Additional cores 230B-230D may couple to last level cache 295 as well.

In various embodiments, uncore 290 (sometimes referred to as a system agent) may include any suitable logic that is not a part of core 230. For example, uncore 290 may include one or more of a last level cache, a cache controller, an on-die memory controller coupled to a system memory, a processor interconnect controller (e.g., a Quick Path Interconnect or similar controller), an on-die I/O controller, or other suitable on-die logic.

In particular embodiments, uncore 290 may be in a voltage domain and/or a frequency domain that is separate from voltage domains and/or frequency domains of the cores. That is, uncore 290 may be powered by a supply voltage that is different from the supply voltages used to power the cores and/or may operate at a frequency that is different from the operating frequencies of the cores.

CPU 112 may also include a power control unit (PCU) 240. In various embodiments, PCU 240 may control the supply voltages and the operating frequencies applied to each of the cores (on a per-core basis) and to the uncore. PCU 240 may also instruct a core or uncore to enter an idle state (where no voltage and clock are supplied) when not performing a workload.

In various embodiments, PCU 240 or other logic of system 100 may detect one or more stress characteristics of a hardware resource, such as cores, uncores, NICS, acceleration components (e.g., FPGAs or ASICs), storage devices (e.g., disk drives or disk controllers), or other suitable hardware resources. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 240 may detect stress characteristics at any suitable interval.

In various embodiments, PCU 240 may comprise a microcontroller that executes embedded firmware to perform various operations associated with stress monitoring described herein. In one embodiment, PCU 120 performs some or all of the PCU functions described herein using hardware without executing software instructions. For example, PCU 120 may include fixed and/or programmable logic to perform the functions of the PCU.

In various embodiments, PCU 120 is a component that is discrete from the cores 230. In particular embodiments, the PCU 120 runs at a clock frequency that is different from the clock frequencies used by cores 230. In some embodiments where PCU is a microcontroller, PCU 120 executes instructions according to an ISA that is different from an ISA used by cores 230.

In various embodiments, CPU 112 may also include a non-volatile memory 250 to store stress information (such as stress characteristics, incremental stress values, accumulated stress values, stress accumulation rates, or other stress information) associated with cores 230 or uncore 290, such that when power is lost, the stress information is maintained.

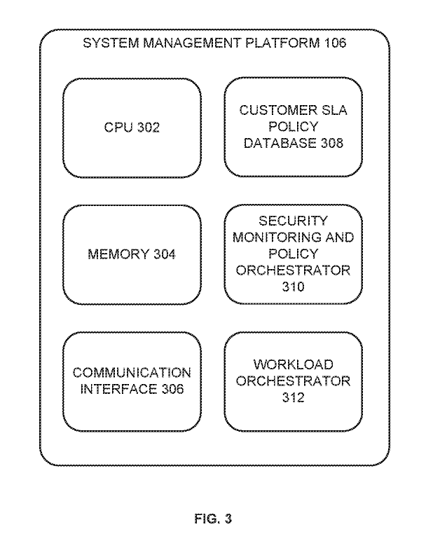

FIG. 3 illustrates a block diagram of a system management platform 106 in accordance with certain embodiments. System management platform 106 includes, among any other suitable hardware, at least one CPU 302, memory 304, and communication interface 306 which may include any suitable characteristics as described above with respect to CPUs 112, memory 114, and communication interface 118 to facilitate the operations of system management platform 106. In various embodiments, system management platform 106 may be distinct from the platforms 102 of computer system 100 (e.g., it may reside in one or more different physical modules or on one or more different circuit boards). In other embodiments, the functionality of system management platform 106 may be performed by any suitable components of platform logic 110 of one or more platforms 102. System management platform 106 may be in communication with each of the platforms 102 through communication interface 306 and may collect telemetry data from the platforms 102 and direct the platforms to perform workload placement as described herein. In one embodiment, communication interface 306 uses an out-of-band approach to communicate with manageability engines 126 and an in-band approach to communicate directly with the hypervisors 120 or operating systems running on the platforms 102.

Customer service level agreement (SLA) policy database 308 includes logic to associate an application running on one or more platforms 102 with an SLA so that system management platform 106 may evaluate whether performance targets are being met with respect to the application. SLAs may be based on any suitable metrics, such as metrics associated with virtual machine or VNF operations (e.g., virtual machine provisioning latency and reliability, virtual machine clock error, virtual machine dead on arrival, etc.) or virtual network operations (e.g., packet delays, delay variations, network outages, port status, policy integrity, etc.).

Security monitoring and policy orchestrator 310 may include logic for monitoring and managing security within computer system 100. For example, security monitoring and policy orchestrator 310 may include intrusion detection and mitigation, denial of service detection and mitigation, antivirus, and other security functions. Security monitoring and policy orchestrator 310 may maintain a global view of computer system 100 and deployments of virtual machines 132 within the computer system from a security standpoint as well as manage interconnections between various segments of networks within computer system 100 (e.g., the communication/bridging across various VLANs).

Workload orchestrator module 312 includes logic to monitor workloads on platforms 102 of the computer system and to direct placement for those workloads. Module 312 may communicate with manageability engines 126 from various platforms 102, and/or hypervisors 120 or other operating systems from various platforms to receive telemetry data, determine suitable workload placement, and direct the placement of the workloads.

In various embodiments of the present disclosure and as described above, various stress characteristics of hardware resources (e.g., cores, uncores, or components thereof) of computer system 100 may be periodically measured. Such measurements may be performed by PCUs 240 or other suitable logic of CPUs 112 or chipsets 116. In some embodiments, measurements may be performed by sensing or may be performed by recording known inputs (such as a voltage and/or frequency applied to a hardware resource) or deriving stress characteristics therefrom. The stress characteristics may include any suitable characteristics that are indicative of stress placed on the hardware resources (where increased stress reduces the expected life of the hardware resource). In a particular embodiment, the stress characteristics include voltages applied to the hardware resources and sensed temperatures of the hardware resources.

Incremental stress values may be calculated based on the measured values of the stress characteristics. The incremental stress values may be calculated by any suitable logic, such as PCUs 240 or other suitable logic of CPUs 112, manageability engines 126 or other suitable logic of chipset 116A, other logic of platform logic 110, datacenter management platform 106, or other suitable logic of computer system 100. In various embodiments, the entity that measures the values of the stress characteristics may calculate the incremental stress values or may communicate the stress characteristics to another entity that calculates the incremental stress values. In general, an entity may collect and/or calculate stress information for associated hardware components. For example, CPU 112A may collect stress information for hardware resources located on CPU 112A, CPU 112B may collect stress information for hardware resources located on CPU 112B, etc. As another example, manageability engine 126A may calculate stress information for hardware resources of cores 112 managed by the manageability engine 126A, manageability engine 126B may calculate stress information for hardware resources of cores 112 managed by the manageability engine 126B, etc.

An incremental stress value may be calculated based on one or more measured values of the stress characteristics in any suitable manner and may have any suitable unit of stress (e.g., a stress-hour). An incremental stress value may indicate the amount of stress placed upon the hardware resource over the time period of the relevant stress characteristics. Thus, an incremental stress value may be indicative of the amount of lifetime of the hardware resource that was used up during the time period.

In one embodiment, an incremental stress value may be calculated by using an ageing equation with voltage applied to the hardware resource (or voltage sensed at the hardware resource) and temperature of the hardware resource as inputs to the equation. In one embodiment, an incremental stress value may be calculated by multiplying the length of time over which the incremental stress value is calculated by one or more acceleration factors (such as a temperature acceleration factor, a voltage acceleration factor, and/or other acceleration factor). For example, an incremental stress value may be obtained by multiplying the length of time by a temperature acceleration factor and a voltage acceleration factor.

If the temperature over the length of time is equal to a reference temperature then the temperature acceleration factor will be equal to one, if the temperature is lower than the reference temperature, the temperature acceleration factor will be less than one (indicating slower aging), and if the temperature is greater than the reference temperature then the temperature acceleration factor will be greater than one (indicating faster aging). Similarly, if the voltage over the length of time is equal to a reference voltage then the voltage acceleration factor will be equal to one, if the voltage is lower than the reference voltage, the voltage acceleration factor will be less than one (indicating slower aging), and if the voltage is greater than the reference voltage then the voltage acceleration factor will be greater than one (indicating faster aging).

In a particular embodiment, a temperature acceleration factor is calculated as:

$$exp [ ( \frac{{E}_{a}}{k} ) \times ( \frac{1}{{T}_{ref}} - \frac{1}{{T}_{use}} ) ]$$

where Eₐ/k is a constant dependent on process characteristics, T_{ref} is the reference temperature, and Tᵤₛₑ is the sensed temperature over the length of time.

In a particular embodiment, a voltage acceleration factor is calculated as:

exp[C×(Vᵤₛₑ−V_{ref})]

where C is a constant dependent on process characteristics, Vᵤₛₑ is the voltage applied over the length of time, and V_{ref} is a reference voltage.

In other embodiments, the temperature acceleration factor and/or voltage acceleration factor (and/or other acceleration factor based on another operating characteristic) may be calculated in any other suitable manner.

Incremental stress values for each hardware resource may be accumulated over time and stored by any suitable entity (e.g., in non-volatile memory 132 by manageability engine 126, non-volatile memory 250 by CPU 112, or other suitable memory by another entity). The accumulated stress value may be indicative of the amount of the expected lifetime of the hardware resource that has been used up (and thus also indicative of the expected lifetime remaining for the hardware resource. Like the incremental stress values, the accumulated stress value may have any suitable units, such as stress-hours or other suitable unit. The accumulated stress values may be calculated and stored at any suitable interval, such as per day, per week, or other suitable interval. In various embodiments, an accumulated stress value may comprise an accumulation of incremental stress values, but is not limited thereto. An accumulated stress value may represent any suitable estimation of the accumulated stress on a hardware resource. As an example, in some embodiments, an accumulated stress value may be calculated by adjusting an accumulation of incremental stress values. As another example, in some embodiments, an accumulated stress value may be calculated based, at least in part, on a diagnostic test performed on the hardware resource (or a related hardware resource). Other suitable methods of calculating an accumulated stress value are also contemplated.

In various embodiments, each hardware resource may be associated with one or more threshold stress values. A threshold stress value may have similar units to an accumulated stress value. A threshold stress value may indicate how close the hardware resource is to failure. In a particular embodiment, a hardware resource may be associated with a preliminary threshold stress value and a primary threshold stress value (in other embodiments, any suitable number of threshold stress values may be used). Any suitable logic of a platform 102 or computer system 100 may periodically (or in response to a request) determine whether the accumulated stress value of a hardware resource has crossed the preliminary threshold stress value and/or the primary threshold stress value. In response to a determination that the accumulated stress value of a hardware resource is greater than a threshold stress value, a stress indicator may be communicated to any suitable entity. For example, the stress indicator may be communicated to a manageability engine 126, a hypervisor 120 or other operating system, datacenter management platform 106, or to a computing device associated with an administrator of computer system 100 such that appropriate action regarding workload placement or hardware resource diagnostics may be initiated. Such actions will be described in further detail below. The stress indicator may list the accumulated stress value, which particular threshold stress value was exceeded, or other suitable stress information described herein.

The threshold stress values may be based on any suitable information. In various embodiments, information regarding the expected life of a hardware resource under particular use conditions may be provided (e.g., on a per stock keeping unit (SKU) basis) by a manufacturer of the hardware resources based on quality and reliability testing performed by the manufacturer. For example, the information may specify that under expected use conditions a hardware resource is expected to last 10 years. Accordingly, as an example, the primary threshold stress value may be set to 10 stress years (i.e., 87660 stress hours) and the preliminary threshold stress value may be set to 9 stress years (other embodiments may use any suitable units to represent life in terms of stress). In various embodiments, the threshold stress values may be configurable (e.g., by an administrator of computer system 100 or by logic of the computer system 100) or may be hard coded by the manufacturer based on the expected life of the hardware resource and the desired risk tolerance. In various embodiments, the threshold stress values may vary from hardware resource to hardware resource. For example, the cores of CPU 112A may be expected to have a slightly different lifespan as compared to the cores of CPU 112B due to process variations. As another example, the uncore 290 or a component thereof may have a different lifespan as compared to a core of a CPU 112.

In various embodiments, as the age of a hardware resource rises, the minimum applied voltage that will allow the hardware resource to operate without error rises. For illustrative purposes only, a new core may be able to operate without errors at 0.8 V while a core that is effectively 10 years old (i.e., has accumulated 10 stress-years) may operate without errors at 1 V and above. The voltage at which a hardware resource may operate without errors may be referred to as Vmin. In particular embodiments, the effective age (i.e., accumulated stress value) of the hardware resource may (at least loosely) correspond to the change in Vmin of the hardware resource (as the Vmin rises so does the effective age). Once Vmin rises to a particular level, operational errors may be expected. Accordingly, a threshold stress value used to generate a stress indicator may be set to a level at or below the stress value at which errors are expected to occur because the Vmin has risen. In a particular embodiment, a primary threshold stress value for a hardware resource may be set to an expected lifetime of the hardware resource under reference use conditions, though the primary threshold stress value may be set by a user to any suitable value. In a particular embodiment, the preliminary threshold stress value is set to 90% of the primary threshold stress value, though any suitable relationship among threshold stress values may be allowed in other embodiments.

In various embodiments, a diagnostic test (e.g., to determine Vmin) on a hardware resource may be run at any suitable time. For example, the test may be run after a stress indicator is generated for the hardware resource due to the accumulated stress value of the hardware resource crossing a threshold stress value. The diagnostic test may be run by blocking workloads from being placed on the hardware resource and then running a test sequence at multiple different operating voltages. Based on the results of the test, the actual Vmin is discovered and may be used to adjust one or more threshold stress values or accumulated stress values. For example, if the accumulated stress value corresponds with an estimated Vmin that is materially higher than the actual measured Vmin, the threshold stress value may be adjusted upward accordingly (because the hardware resource has not aged as much as was estimated by the accumulated stress value) or the accumulated stress value may be adjusted downward accordingly. In addition or as an alternative, the hardware resource may be tested to determine whether it has reached end-of-life (e.g., whether it can pass a test sequence checking for errors).

In various embodiments, data from one or more diagnostic tests may be used to tune one or more stress value characteristics (e.g., accumulated stress values, threshold stress values, and/or methodologies for determining incremental stress values). If the diagnostic test reveals that stress is accumulating at an expected rate, then stress is being measured accurately. If one or more diagnostic tests reveal that stress is accumulating at a greater than expected rate, then one or more accumulated stress values may be reduced accordingly, one or more threshold stress values may be raised accordingly, and/or a methodology for determining incremental stress values may be changed such that the incremental stress values are adjusted by a factor to decrease incremental stress values relative to incremental stress values measured under the same conditions before the adjustment, and vice versa if the one or more diagnostic tests reveal that stress is accumulating more slowly than expected. Not only may the stress value characteristics be adjusted for the hardware resource on which the one or more tests were performed, but stress value characteristics may be adjusted for one or more associated hardware resources. For example, if a diagnostic test reveals that stress value characteristics associated with a particular core should be adjusted, then stress value characteristics of one or more cores (e.g., cores on the same die or package as the core that was tested) or uncores associated with the core may also be adjusted. As another example, if two related hardware resources are tested and the diagnostic tests reveal that the stress value characteristics of the hardware resources should be adjusted in a similar manner, then other hardware resources that are expected to behave in a similar manner (e.g., they are on the same die or package, they have the same SKU, etc.) as the hardware resources may have their associated stress value characteristics adjusted based on the diagnostic tests.

In various embodiments, a stress accumulation rate of each hardware resource may be determined (e.g., by manageability engine 126 or other suitable logic of computer system 100) by determining the amount of stress incurred over a particular period of time for the hardware resource. The stress accumulation rate may be updated periodically or at any other suitable time. In one embodiment, the accumulated stress value at a particular instance of time may be stored and compared against the accumulated stress value at a later instance of time to determine the stress accumulation rate.

In various embodiments, the stress accumulation rate of a hardware resource may be compared against an expected stress accumulation rate. The expected stress accumulation rate may be calculated based on the expected life of the hardware resource under particular (e.g., typical) use conditions. In various embodiments, an indication of whether the hardware resource is accumulating stress at a faster than expected rate, at the normal rate, or at a slower than expected rate may be stored. In various embodiments, a quantification of how much faster or slower the stress accumulation rate is compared to the expected stress accumulation rate could be stored. The stress accumulation rate may be calculated at any suitable interval, such as once per day, once per week, or other suitable interval.

The various accumulated stress values, stress accumulation rates, stress indicators, or other stress information may be used to increase the reliability and capacity utilization of one or more platforms 102. This stress information may be provided to any suitable entity to make decisions about workload placement based on the stress information. For example, the stress information may be accessed by system management platform 106 (e.g., by workload orchestrator 212); a platform comprising an NFV management and organization (MANO) that on-boards workloads and provides lifecycle management of workloads; hypervisor 120 (e.g., by resource allocation logic 144) or other operating system; CPUs 112 (e.g., by PCU 240), or other logic of platform 102 or computer system 100 to make workload placement decisions (either alone or in combination with other elements of the platform 102). “Workload orchestration logic” may be used herein to refer to any one of these entities, or to a group of these entities that may work together to perform workload placement decisions. In a particular embodiment workload orchestration logic may access the stress information from any suitable entities (e.g., manageability engines 126) in an in-band or out-of-band manner.

Various types of workload placement may be performed by workload orchestration logic based on the stress information, such as selecting particular hardware resources of platform logic 110 for an instantiation of a virtual machine 132, a VNF 134, or SFC 136 (or other workload); deciding where to place a process associated with a particular virtual machine or group of virtual machines; directing the migration of a virtual machine 132, VNF 134, or SFC 136 (or other workload) from hardware resources on one platform (e.g., 102A) to hardware resources of another platform (e.g., 102B); selecting a hardware resource to route an interrupt to; avoiding the placement of workloads on particular resources (e.g., because these resources have been retired due to reaching their end-of-life); directing (or migrating) a thread to a particular core within a CPU; or other suitable workload placement decisions.

In some embodiments, high importance workloads and/or fault intolerant workloads may be steered away from hardware resources that have reached end-of-life or are nearing end-of-life (e.g., as indicated by a stress indicator generated for a particular hardware resource). In various embodiments, as workloads are distributed among the hardware resources, the workload orchestration logic may steer a greater number of workloads to the hardware resources that have lower accumulated stress values (and/or longer estimated remaining life). In certain instances, hardware resources that have higher accumulated stress values or have accumulated stress values above particular thresholds are assigned less workloads, workloads that are less critical than others, or may be avoided altogether. Workloads may be balanced across hardware resources based on stress information to perform wear leveling, such that a particular hardware resource does not accumulate stress at a higher rate than other associated hardware resources.

In various embodiments, system level compute resource allocation may be performed based on the stress information. For example, “pooled” compute resources (e.g., compute, networking, and storage components) may be allocated based on pre-determined limits attached to hardware components. For example, a pooled resource may comprise an aggregation of multiple types of hardware resources. For example, a pooled resource may comprise one or more server CPU cores, acceleration resources (either reprogrammable FPGA or purpose-build ASICs), NIC resources, and/or storage resources that are coupled together and operate with each other. In various embodiments, an orchestrator (or controller) may compare the stress information against a set of pre-determined metrics and allocate pooled resources accordingly. As one example, to ensure compliance with a networking uptime SLA, a cellular provider could orchestrate (e.g., from a server pool) allocation of a number of separate servers that have favorable wear indicators (e.g., hours used or remaining life) for a particular wireless network. Once a server crosses a threshold associated with the stress information (e.g., a threshold stress value or other threshold value), that server may be removed from the server pool and earmarked for replacement. The threshold values may be specified for a pooled resource in any suitable manner. For example, in one embodiment, the worst stress information (e.g., accumulated stress value) for a particular hardware component of a pooled resource may be imputed to the entire pooled resource (e.g., server) and compared against a threshold. As another example, the stress information for groups of different types of hardware components may be assimilated to form group-specific indicators and the indicator associated with the worst group may be imputed to the pooled resource (e.g., an average accumulated stress value may be performed for the cores of a server or for the NICs of a server). Any other suitable allocation strategy using any suitable stress thresholds may be implemented that utilizes the stress information described herein.

In various embodiments, policies can be set up to keep track of separate SLAs with different thresholds of stress information. For example, a provider may provide a first group of users with a first category of service in accordance with an SLA specifying high compute reliability, a second group of users with a second category of service in accordance with an SLA specifying moderate reliability, and a third group of users with a third category of service not associated with an SLA (or with an SLA specifying low reliability). Each category of service may be associated with different stress thresholds. For example, pooled resources allocated to serve the first group of users may only include resources with accumulated stress values below a first threshold (such that the newest pooled resources are used), pooled resources allocated to serve the second group of users may include pooled resources with accumulated stress values below a second threshold (that is higher than the first threshold), and pooled resources allocated to server the third group of users may include any of the pooled resources. In various embodiments, a provider may charge differently depending on the SLA.

In a particular embodiment, the stress information may be tracked and stored over time in order to provide evidence of the performance of particular pooled resources. For example, the evidence may show that a particular platform performed as required under an SLA.

The workload orchestration logic may also initiate testing (such as described above) for one or more of the hardware resources based on the stress information to more accurately determine how much remaining life the hardware resource has.

In various embodiments, workload orchestrator 212 may use stress indicators as a VNF capacity parameter, thus providing the ability to plan for capacity using information about available hardware resources as well as stress indicators indicative of reliability. Workload orchestrator 212 may use the stress indicators to select the suitable hardware platform in creating the VNFs distributed on hardware such that pre-determined reliability or SLA requirements can be met.

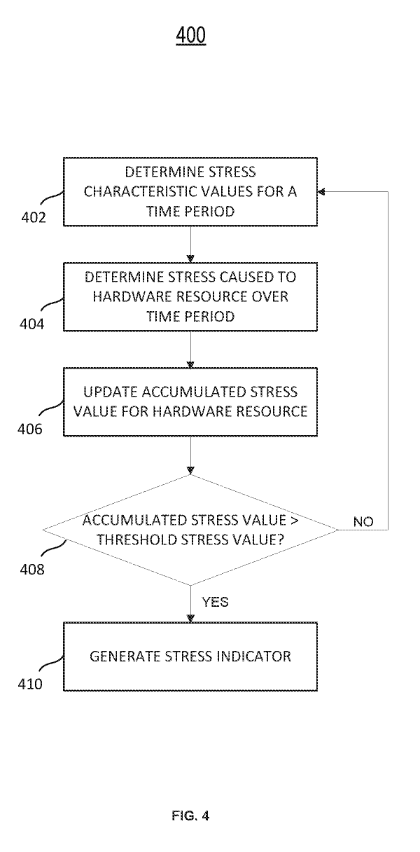

FIG. 4 illustrates an example flow for generating a stress indicator based on an accumulated stress value of a hardware resource in accordance with certain embodiments. In various embodiments, one or more of the operations may be performed by any suitable logic of computer system 100.

At 402, stress characteristic values (e.g., voltages and temperatures) of a particular hardware resource are determined for a period of time. At 404, stress caused to the hardware resource is determined for the time period. In various embodiments, the stress caused is based on the stress characteristic values. At 406, an accumulated stress value for the hardware resource is updated by adding the stress caused over the time period to the previously recorded total stress experienced by the hardware resource.

At 408, it is determined whether the accumulated stress value is greater than a threshold stress value. If the accumulated stress value isn't greater than the threshold stress value, the hardware source continues to be monitored and its accumulated stress value updated at operations 402-406. If the accumulated stress value is greater than the threshold stress value, a stress indicator is generated at 410. The accumulated stress value may continue to be monitored and its accumulated stress value updated at operations 402-406 or the monitoring may stop (e.g., to execute a test on the hardware resource or to retire the hardware resource).

The flow described in FIG. 4 is merely representative of operations that may occur in particular embodiments. In other embodiments, additional operations may be performed by the components of system 100. Some of the operations illustrated in FIG. 4 may be repeated, combined, modified or deleted where appropriate. Additionally, operations may be performed in any suitable order without departing from the scope of particular embodiments.

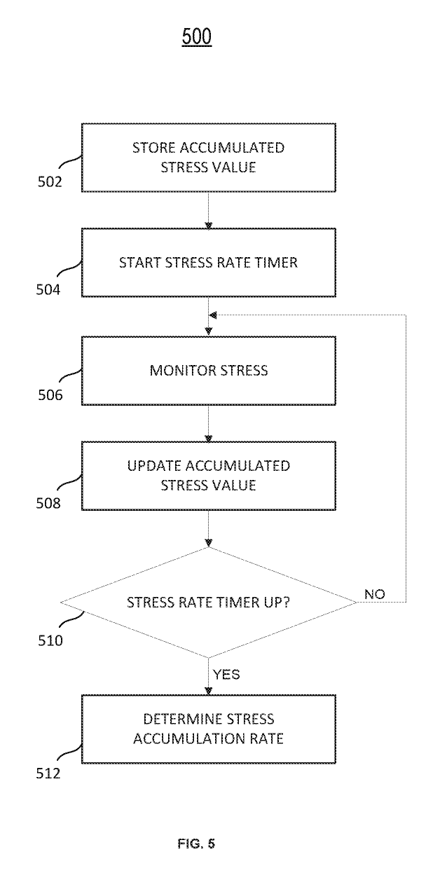

FIG. 5 illustrates an example flow for determining a stress accumulation rate for a hardware resource in accordance with certain embodiments. In various embodiments, one or more of the operations may be performed by any suitable logic of computer system 100.

At 502, an accumulated stress value for a hardware resource is stored. At 504, a stress rate timer is started. The timer may be set for any suitable length of time, such as a day, a week, or other length of time. While the timer is running, the stress experienced by the hardware resource is monitored at 506 and an accumulated stress value is updated at 508. At 510, if the timer is not yet up, the stress is monitored and the accumulated stress value updated accordingly again. Once the stress rate timer is up a stress accumulation rate for the hardware resource is determined. In one embodiment, the stress accumulation rate may be determined as the difference between the accumulated stress value at the time the timer expired and the accumulated stress value at the time the timer was started over the length of time measured by the timer. In some embodiments, the stress accumulation rate may be compared with an expected stress accumulation rate calculated based on the expected lifetime of the hardware resource and an indication of the stress accumulation rate and/or whether the stress accumulation rate is higher or lower than the expected stress accumulation rate may be stored in association with the hardware resource.

The flow described in FIG. 5 is merely representative of operations that may occur in particular embodiments. In other embodiments, additional operations may be performed by the components of system 100. Some of the operations illustrated in FIG. 5 may be repeated, combined, modified or deleted where appropriate. Additionally, operations may be performed in any suitable order without departing from the scope of particular embodiments.

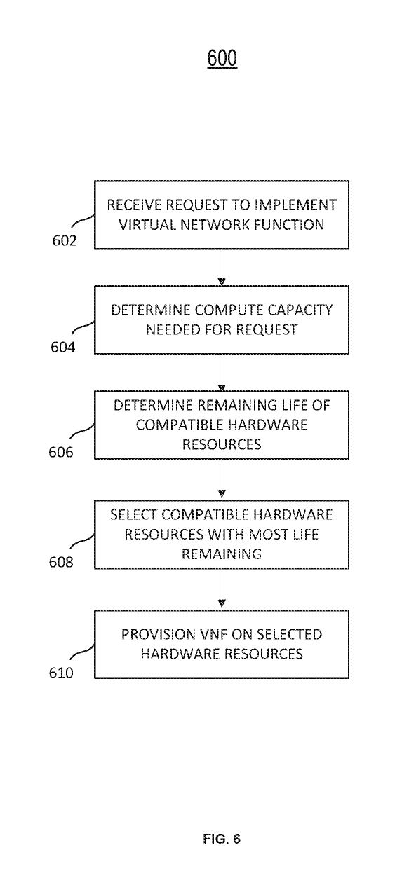

FIG. 6 illustrates an example flow for selecting hardware resources for a workload based on remaining life of hardware resources in accordance with certain embodiments. In various embodiments, one or more of the operations may be performed by any suitable logic of computer system 100.

At 602, a request to implement a virtual network function or other workload is received. At 604, the compute capacity needed to fulfill the request is determined. At 606, the remaining life of hardware resources that are compatible with the request are determined. For example, stored accumulated stress values may be accessed for each of the compatible hardware resources. As another example, indications of the remaining life (based on accumulated stress values and expected lifetimes) of the compatible hardware resources are accessed. As another example, for each compatible hardware resource, it may be determined whether a stress indicator has been generated for the hardware resource.

In various embodiments, the compatible hardware resources may be determined in any suitable manner. For example, requirements of the workload may be checked against an SKU, cache type, supported bus, QuickPath Interconnect (QPI) (or other interconnect) version, or other suitable characteristic of CPU 112 to determine whether the workload may be run by a core of the CPU. If any hardware resources are incompatible with the workload, they may be omitted from the analysis at 606.

At 608, the compatible hardware resources with the most life remaining are selected. In one example, the compatible hardware resources may be ranked according to remaining life and hardware resources with the most remaining life are selected until the compute capacity needed for the request is met by the selected hardware resources. In another example, compatible hardware resources that have not yet had stress indicators generated (for crossing a threshold stress value) are selected. At 610, the VNF is provisioned (or other workload is performed) on the selected hardware resources.

The flow described in FIG. 6 is merely representative of operations that may occur in particular embodiments. In other embodiments, additional operations may be performed by the components of system 100. Some of the operations illustrated in FIG. 6 may be repeated, combined, modified or deleted where appropriate. Additionally, operations may be performed in any suitable order without departing from the scope of particular embodiments.

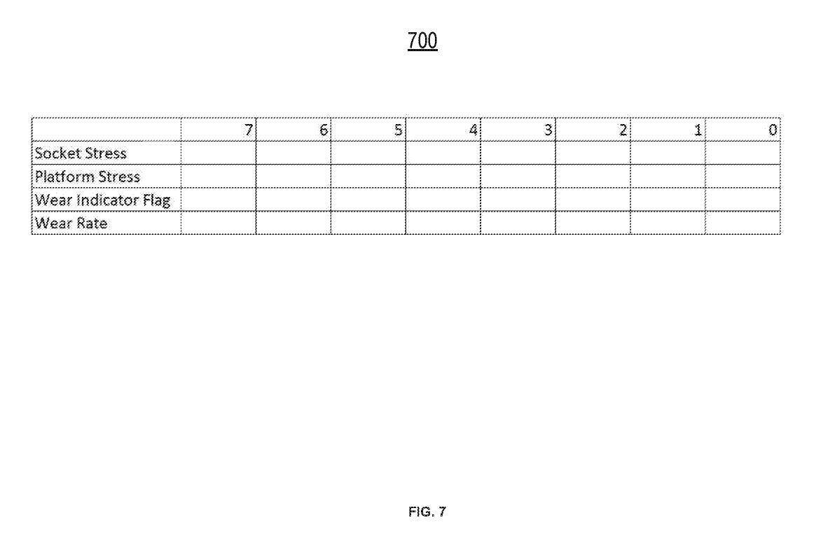

FIG. 7 depicts an example data structure 700 that may be used to track stress information of a plurality of hardware resources. Structure 700 may include, for each hardware resource (e.g., resources 0-7 in the depicted embodiment), memory to store stress information associated with the particular resource. In the embodiment depicted, a socket stress value, platform stress value, wear indicator value, and wear rate may be stored for each hardware resource. Any subset of these (or other stress information values) may be stored for each hardware resource in various embodiments.

The socket stress value may indicate an absolute ranking of the hardware resource (e.g., a core) within a socket (comprising multiple cores) or an abstracted ranking (e.g., best category, middle category, worst category) of the core within the socket. The platform stress value may indicate an absolute ranking of the hardware resource (e.g., a core) within a platform (which may comprise multiple sockets) or an abstracted ranking (e.g., best category, middle category, worst category) of the core within the platform.

The wear indicator value may indicate an absolute wear value (e.g., accumulated stress value) or an abstracted wear value. As one example, a wear indicator value may indicate whether the wear is less than a first threshold (e.g., 90% of expected life), between the first threshold and a second threshold (e.g., 100% of expected life), or greater than the second threshold.

The wear rate value may indicate an absolute wear rate or an abstracted wear rate. For example, the wear rate value may indicate whether a wear rate is less than a nominal wear rate (e.g., an expected wear rate at reference use conditions), whether a wear rate is within a threshold of a nominal wear rate, or whether a wear rate is greater than a nominal wear rate.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware.

Logic may be used to implement any of the functionality of the various components such as platform logic 110, CPU 112, chipset 116, manageability engine 126, communication interface 118, 128, or 306, hypervisor 120, I/O device driver 124, guest system 122, datacenter management platform 106, PCU 240, workload orchestrator 312, or other entity or component described herein or depicted in the figures. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

In at least one embodiment, a system comprises a plurality of hardware resources, the plurality of hardware resources comprising at least one processor core; and platform logic to determine, at a plurality of instances in time, a value of at least one stress characteristic of a hardware resource of the plurality of hardware resources; determine an accumulated stress value of the hardware resource, the accumulated stress value comprising the sum of a plurality of incremental stress values, an incremental stress value determined based on the value of the at least one stress characteristic at a particular instance in time; and generate a first stress indicator in response to a determination that the accumulated stress value of the hardware resource is greater than a first threshold stress value associated with the hardware resource.

In an embodiment, the platform logic is further to determine whether a stress accumulation rate of the hardware resource is greater than a threshold stress accumulation rate of the hardware resource. In an embodiment, the at least one stress characteristic comprises a voltage applied to the hardware resource. In an embodiment, the at least one stress characteristic comprises a temperature of the hardware resource. In an embodiment, the platform logic is further to store the accumulated stress value in a non-volatile memory of a computing platform comprising the hardware resource. In an embodiment, the hardware resource is a processor core and the non-volatile memory is located on the same die as the processor core. In an embodiment, the platform logic is further to communicate a second stress indicator in response to a determination that the accumulated stress value of the hardware resource is greater than a second threshold stress value associated with the hardware resource. In an embodiment, the system further comprises workload orchestration logic to assign one or more of the plurality of hardware resources to a workload based at least in part on the accumulated stress value of the hardware resource. In an embodiment, the system further comprises workload orchestration logic to migrate a workload from a first set of one or more of the plurality of hardware resources to a second set of one or more of the plurality of hardware resources based at least in part on the accumulated stress value of the hardware resource. In an embodiment, the system further comprises workload orchestration logic to perform wear leveling of the plurality of hardware resources based at least in part on the accumulated stress value of the hardware resource. In an embodiment, the hardware resource is a processor core. In an embodiment, the hardware resource is an uncore comprising logic on a central processing unit that has a voltage domain that is separate from a voltage domain of the at least one processor core. In an embodiment, the platform logic is further to apply a plurality of voltages to the hardware resource to determine a minimum operating voltage that allows a test sequence to execute error free; and adjust the first threshold stress value based on the determined minimum operating voltage. In an embodiment, the platform logic is further to select a pooled resource comprising a plurality of different types of hardware resources based on an accumulated stress value of at least one hardware resource of each type of the different types of hardware resources.

In at least one embodiment, a method comprises determining, at a plurality of instances in time, a value of at least one stress characteristic of a hardware resource of a plurality of hardware resources; determining an accumulated stress value of the hardware resource, the accumulated stress value comprising the sum of a plurality of incremental stress values, an incremental stress value determined based on the value of the at least one stress characteristic at a particular instance in time; and generating a first stress indicator in response to a determination that the accumulated stress value of the hardware resource is greater than a first threshold stress value associated with the hardware resource.

In an embodiment, the method further comprises determining whether a stress accumulation rate of the hardware resource is greater than a threshold stress accumulation rate of the hardware resource. In an embodiment, the at least one stress characteristic comprises a voltage applied to the hardware resource. In an embodiment, the at least one stress characteristic comprises a temperature of the hardware resource. In an embodiment, the method further comprises storing the accumulated stress value in a non-volatile memory of a computing platform comprising the hardware resource. In an embodiment, the hardware resource is a processor core and the non-volatile memory is located on the same die as the processor core. In an embodiment, the method further comprises communicating a second stress indicator in response to a determination that the accumulated stress value of the hardware resource is greater than a second threshold stress value associated with the hardware resource. In an embodiment, the method further comprises assigning one or more of the plurality of hardware resources to a workload based at least in part on the accumulated stress value of the hardware resource. In an embodiment, the method further comprises migrating a workload from a first set of one or more of the plurality of hardware resources to a second set of one or more of the plurality of hardware resources based at least in part on the accumulated stress value of the hardware resource. In an embodiment, the method further comprises performing wear leveling of the plurality of hardware resources based at least in part on the accumulated stress value of the hardware resource. In an embodiment, the hardware resource is a processor core. In an embodiment, the hardware resource is an uncore comprising logic on a central processing unit that has a voltage domain that is separate from the voltage domains of the plurality of processor cores. In an embodiment, a system comprises means to perform any of these methods. In an embodiment, the means comprise machine-readable code that when executed, cause a machine to perform one or more steps of the methods.

In at least one embodiment, at least one machine readable storage medium has instructions stored thereon, the instructions when executed by a machine to cause the machine to determine, at a plurality of instances in time, a value of at least one stress characteristic of a hardware resource; determine an accumulated stress value of the hardware resource, the accumulated stress value comprising the sum of a plurality of incremental stress values, an incremental stress value determined based on the value of the at least one stress characteristic at a particular instance in time; and generate a first stress indicator in response to a determination that the accumulated stress value of the hardware resource is greater than a first threshold stress value associated with the hardware resource.

In an embodiment, the instructions when executed by the machine further cause the machine to determine whether a stress accumulation rate of the hardware resource is greater than a threshold stress accumulation rate of the hardware resource. In an embodiment, the instructions when executed by the machine further cause the machine to communicate a second stress indicator in response to a determination that the accumulated stress value of the hardware resource is greater than a second threshold stress value associated with the hardware resource. In an embodiment, the instructions when executed by the machine further cause the machine to assign one or more of a plurality of hardware resources to a workload based at least in part on the accumulated stress values of the plurality of processor cores. In an embodiment, the hardware resource is a processor core.

In at least one embodiment, a system comprises means to determine, at a plurality of instances in time, a value of at least one stress characteristic of a hardware resource; means to determine an accumulated stress value of the hardware resource, the accumulated stress value comprising the sum of a plurality of incremental stress values, an incremental stress value determined based on the value of the at least one stress characteristic at a particular instance in time; and means to generate a first stress indicator in response to a determination that the accumulated stress value of the hardware resource is greater than a first threshold stress value associated with the hardware resource.

In an embodiment, the system further comprises means to determine whether a stress accumulation rate of the hardware resource is greater than a threshold stress accumulation rate of the hardware resource. In an embodiment, the system further comprises means to communicate a second stress indicator in response to a determination that the accumulated stress value of the hardware resource is greater than a second threshold stress value associated with the hardware resource. In an embodiment, the system further comprises means to assign one or more of a plurality of hardware resources to a workload based at least in part on the accumulated stress values of the plurality of processor cores. In an embodiment, the hardware resource is a processor core.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A system comprising:
a plurality of hardware resources, the plurality of hardware resources comprising at least one processor core; and
platform logic to:
determine, at a plurality of instances in time, a value of at least one stress characteristic of a hardware resource of the plurality of hardware resources;
determine an accumulated stress value of the hardware resource, the accumulated stress value comprising the sum of a plurality of incremental stress values, an incremental stress value determined based on the value of the at least one stress characteristic at a particular instance in time; and
generate a first stress indicator in response to a determination that the accumulated stress value of the hardware resource is greater than a first threshold stress value associated with the hardware resource.

2. The system of claim 1, the platform logic further to determine whether a stress accumulation rate of the hardware resource is greater than a threshold stress accumulation rate of the hardware resource.

3. The system of claim 1, wherein the at least one stress characteristic comprises a voltage applied to the hardware resource.

4. The system of claim 1, wherein the at least one stress characteristic comprises a temperature of the hardware resource.

5. The system of claim 1, the platform logic further to store the accumulated stress value in a non-volatile memory of a computing platform comprising the hardware resource.

6. The system of claim 5, wherein the hardware resource is a processor core and the non-volatile memory is located on the same die as the processor core.

7. The system of claim 1, the platform logic further to communicate a second stress indicator in response to a determination that the accumulated stress value of the hardware resource is greater than a second threshold stress value associated with the hardware resource.

8. The system of claim 1, further comprising workload orchestration logic to assign one or more of the plurality of hardware resources to a workload based at least in part on the accumulated stress value of the hardware resource.

9. The system of claim 1, further comprising workload orchestration logic to migrate a workload from a first set of one or more of the plurality of hardware resources to a second set of one or more of the plurality of hardware resources based at least in part on the accumulated stress value of the hardware resource.

10. The system of claim 1, further comprising workload orchestration logic to perform wear leveling of the plurality of hardware resources based at least in part on the accumulated stress value of the hardware resource.

11. The system of claim 1, wherein the hardware resource is a processor core.

12. The system of claim 1, wherein the hardware resource is an uncore comprising logic on a central processing unit that has a voltage domain that is separate from a voltage domain of a processor core of the at least one processor core.

13. The system of claim 1, wherein the platform logic is further to:
apply a plurality of voltages to the hardware resource to determine a minimum operating voltage that allows a test sequence to execute error free; and
adjust the first threshold stress value based on the determined minimum operating voltage.

14. The system of claim 1, wherein the platform logic is further to select a pooled resource comprising a plurality of different types of hardware resources based on an accumulated stress value of at least one hardware resource of each type of the different types of hardware resources.

15. A method comprising:
determining, at a plurality of instances in time, a value of at least one stress characteristic of a hardware resource;
determining an accumulated stress value of the hardware resource, the accumulated stress value comprising the sum of a plurality of incremental stress values, an incremental stress value determined based on the value of the at least one stress characteristic at a particular instance in time; and
generating a first stress indicator in response to a determination that the accumulated stress value of the hardware resource is greater than a first threshold stress value associated with the hardware resource.

16. The method of claim 15, further comprising determining whether a stress accumulation rate of the hardware resource is greater than a threshold stress accumulation rate of the hardware resource.

17. The method of claim 15, wherein the at least one stress characteristic comprises a voltage applied to the hardware resource and a temperature of the hardware resource.

18. The method of claim 15, further comprising storing the accumulated stress value in a non-volatile memory located on the same die as the hardware resource.

19. The method of claim 15, further comprising communicating a second stress indicator in response to a determination that the accumulated stress value of the hardware resource is greater than a second threshold stress value associated with the hardware resource.

20. The method of claim 15, further comprising assigning one or more of a plurality of hardware resources to a workload based at least in part on the accumulated stress value of the hardware resource.

21. The method of claim 15, further comprising:
applying a plurality of voltages to the hardware resource to determine a minimum operating voltage that allows a test sequence to execute error free; and
adjusting the first threshold stress value based on the determined minimum operating voltage.

22. At least one machine readable storage medium having instructions stored thereon, the instructions when executed by a machine to cause the machine to:
determine, at a plurality of instances in time, a value of at least one stress characteristic of a hardware resource;
determine an accumulated stress value of the hardware resource, the accumulated stress value comprising the sum of a plurality of incremental stress values, an incremental stress value determined based on the value of the at least one stress characteristic at a particular instance in time; and
generate a first stress indicator in response to a determination that the accumulated stress value of the hardware resource is greater than a first threshold stress value associated with the hardware resource.

23. The at least one medium of claim 22, the instructions when executed by the machine to further cause the machine to determine whether a stress accumulation rate of the hardware resource is greater than a threshold stress accumulation rate of the hardware resource.

24. The at least one medium of claim 22, the instructions when executed by the machine to further cause the machine to communicate a second stress indicator in response to a determination that the accumulated stress value of the hardware resource is greater than a second threshold stress value associated with the hardware resource.

25. The at least one medium of claim 22, the instructions when executed by the machine to further cause the machine to assign one or more of a plurality of hardware resources to a workload based at least in part on the accumulated stress value of the hardware resource.
